(19) United States
(12) Patent Application Publication
(10) Pub. No.: US 2006/0071029 A1
(43) Pub. Date: Apr. 6, 2006

(54) Container cartridge for beverage dispenser and support structure thereof

(76) Inventor: Yoshinori Orita, Kakogawa (JP)

Correspondence Address: WENDEROTH, LIND & PONACK, L.L.P., 2033 K STREET N. W., SUITE 800, WASHINGTON, DC, 20006-1021, US

(21) Appl. No.: 11/224,092

(22) Filed: Sep. 13, 2005

(30) Foreign Application Priority Data
Oct. 6, 2004 (JP) 2004-293288
Nov. 8, 2004 (JP) 2004-323549

(51) Int. Cl. B67D 5/06

(52) U.S. Cl. 222/185.1

(57) ABSTRACT

A container cartridge for a beverage dispenser includes a bottom wall, a side wall and a top wall having a spout. The bottom wall, the side wall and the top wall, including the spout, are integrally formed of a polyethylene. The side wall is sufficiently thin so as to be foldable. Thus, after use, i.e. when the container cartridge has become empty, the container cartridge can be collapsed by folding the side wall. The thus collapsed container cartridge can be efficiently transported.

### BACKGROUND OF THE INVENTION

The present invention relates to a container cartridge for a beverage dispenser, and a support structure for the container cartridge.

Among known beverage dispenser systems, there are known one comprising a beverage (such as drinking water or juice) dispenser, and a container cartridge filled with beverage. The container cartridge includes a spout provided on its top through which beverage is introduced into and discharged from the container cartridge, and is set in the dispenser with its spout facing downward such that the spout is connected to an upwardly facing beverage supply port formed on the top surface of the dispenser.

Such a known container cartridge comprises a bottom wall, a side wall and a top wall on which the spout is provided. The bottom wall, side wall and top wall are all made of a synthetic resin and all have rigidity. After use, the container cartridge is recycled or discarded.

Since such a container cartridge has rigidity in its entirety, it remains bulky after use. Thus, such a cartridge cannot be efficiently transported for recycling or disposal.

An object of the present invention is to provide a container cartridge for a beverage dispenser which can be transported efficiently when it is empty.

### SUMMARY OF THE INVENTION

According to the present invention, there is provided a container cartridge for use with a beverage dispenser, comprising a bottom wall, a side wall and a top wall formed with a spout through which beverage is adapted to be introduced into and discharged from the container cartridge, the container cartridge is adapted to be set in the dispenser with the spout facing downward so that the spout is connected to an upwardly facing supply port of the dispenser, whereby beverage in the container cartridge is supplied into the dispenser, at least the side wall being sufficiently flexible so as to be collapsible.

Since at least the side wall is flexible, the used, empty container cartridge can be efficiently transported by collapsing it.

The bottom wall, side wall and top wall, including the spout, are preferably integrally formed of a common thermoplastic synthetic resin, the side wall being sufficiently thin so as to have flexibility. Such a container cartridge can be efficiently manufactured at a low cost.

Preferably, the container cartridge further comprises a carrying handle mounted to the bottom wall. With this arrangement, by carrying the cartridge by the handle, the spout faces downward. Then, simply by lowering the container cartridge onto the dispenser, the spout can be connected to the supply port of the beverage dispenser.

The bottom wall, including the spout, preferably has rigidity so that the spout will not be pushed out of the supply port of the dispenser when the spout is connected to the supply port.

The spout is preferably provided with an engaging portion for engaging a support member such that the container cartridge is hung from the support member with the spout facing upward. With this arrangement, the engaging portion stably keeps the spout in position while the side wall expands spontaneously under the weight of the beverage introduced into the container cartridge through the spout.

The engaging portion may be a flange or a groove formed around the spout.

Preferably, the bottom wall has rigidity, and is provided with a flange or a plurality of claws protruding outwardly of the side wall. The flange or the plurality of claws are brought into engagement with the top of a frame member surrounding the container cartridge to prevent the container cartridge from collapsing during use.

The present invention also provides a support structure for supporting the container cartridge for use with a beverage dispenser, wherein the support structure comprises a frame member supported on the beverage dispenser and surrounding the container cartridge such that the flange or the plurality of claws protruding from the edge of the bottom wall of the container cartridge are adapted to engage the top end of the support structure when the container cartridge is set in the dispenser. The support structure prevents deformation of the container cartridge during use.

### BRIEF DESCRIPTION OF THE DRAWINGS

Other features and objects of the present invention will become apparent from the following description made with reference to the accompanying drawings, in which:

FIG. 1 is a perspective view of a container cartridge for beverage dispenser embodying the present invention;

FIG. 2 is a vertical sectional view of FIG. 1;

FIG. 3 is a perspective view of the container cartridge of FIG. 1, showing its collapsed state;

FIG. 4 is a sectional view of the container cartridge of FIG. 1, as mounted on a beverage dispenser;

FIG. 5 is a perspective view of a container cartridge support structure according to the present invention;

FIG. 6 is a perspective view of a modification of the container cartridge of FIG. 1;

FIG. 7A is a perspective view of a container cartridge according to another embodiment of the invention;

FIG. 7B is a vertical sectional view of FIG. 7A;

FIG. 8 is a perspective view of the container cartridge of FIGS. 7A and 7B, showing how beverage is introduced into the container cartridge;

FIG. 9 is a sectional view of the container cartridge of FIGS. 7A and 7B, as mounted on a beverage dispenser;

FIG. 10 is a perspective view of a modification of the container cartridge of FIGS. 7A and 7B; and

FIG. 11 is a perspective view of the container cartridge of FIG. 10, showing how beverage is introduced into the container cartridge.

### DETAILED DESCRIPTION OF THE PREFERRED EMBODIMENTS

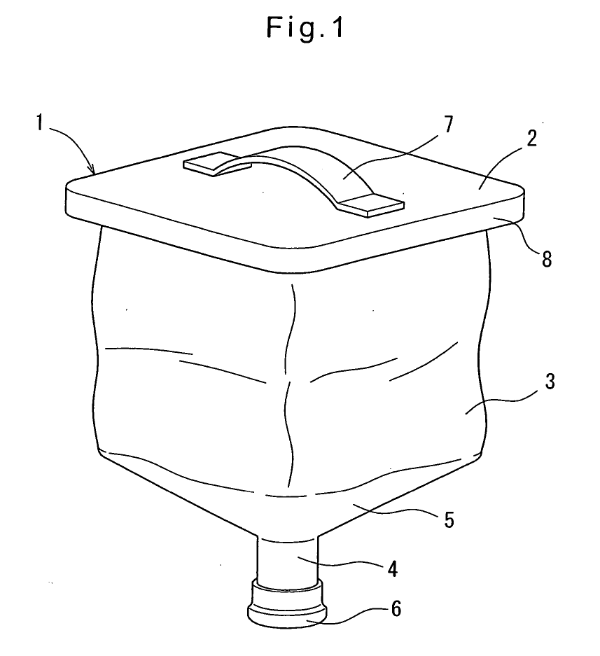

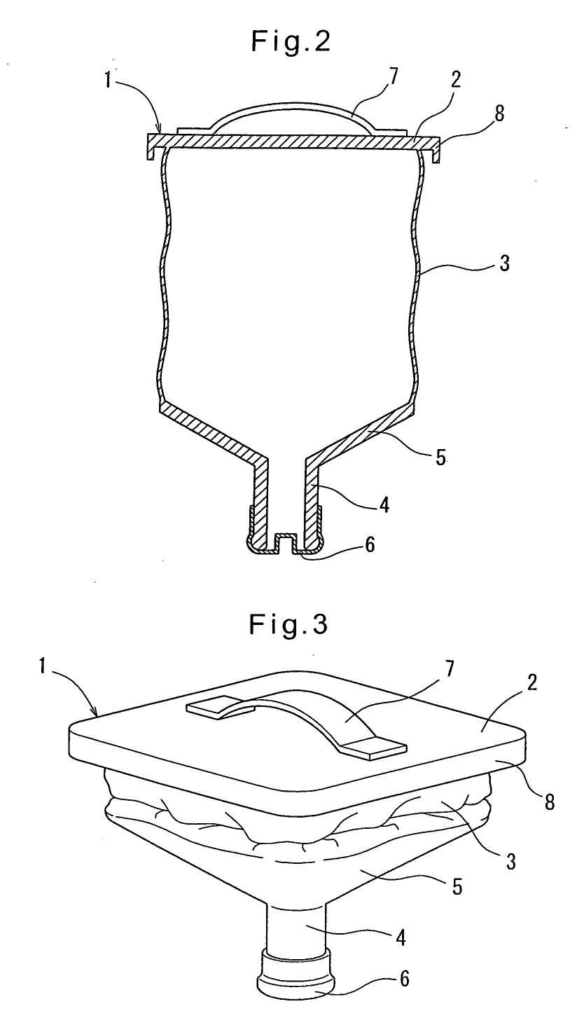

Now referring to the drawings, FIGS. 1 to 6 show the first embodiment. As shown in FIGS. 1 and 2, the container cartridge 1 for a beverage dispenser of the first embodiment is a substantially box-shaped bottle including a bottom wall 2, a side wall 3 and a top wall 5 formed with a spout 4. The bottom wall 2, side wall 3 and top wall 5 are integrally formed of a polyethylene, i.e. a thermoplastic resin. A cap 6 is put on the spout 4 to keep a beverage such as drinking water or juice sealed in the container. The bottom wall 2 and the top wall 5, including the spout 4, have a sufficiently large thickness for rigidity. A carrying handle 7 is fastened to the bottom wall 2. The bottom wall 2 has a flange 8 protruding outwardly of the side wall 3.

The side wall 3 is sufficiently thin so that when the cartridge becomes empty, it can be collapsed by folding the side wall as shown in FIG. 3. The thus collapsed cartridge can be easily and efficiently transported for recycling or disposal.

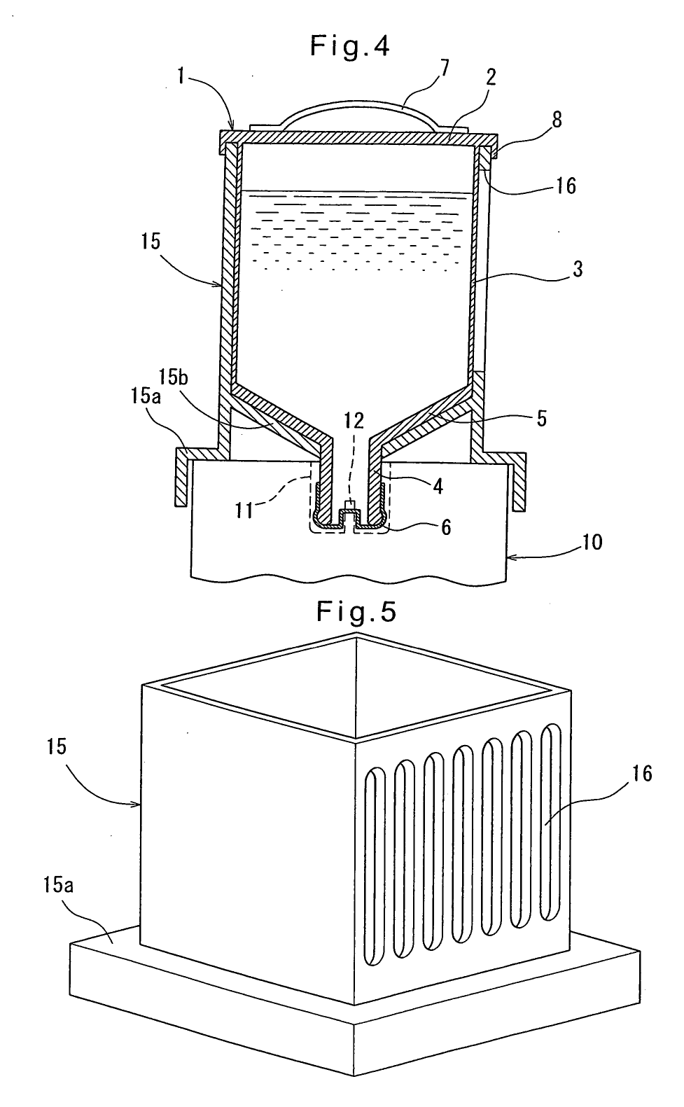

FIG. 4 shows the container cartridge 1 as mounted in a beverage dispenser 10. The beverage dispenser 10 has a beverage supply port 11 in its top surface. A support structure 15 for the container cartridge 1 according to the present invention is supported on the dispenser 10 around the port 11 so as to enclose the dispenser 10.

As shown in FIGS. 4 and 5, the support structure 15 is a substantially box-shaped frame slightly greater in volume than the container cartridge 1, and includes a base 15a supported on the dispenser 10, and a cartridge support 15b for supporting the container cartridge. Vertical slits 16 are formed in one side of the body of the support structure 15 so that the level of the beverage in the container cartridge 1 set in the support structure 15 can be checked therethrough.

To set the container cartridge 1 in the beverage dispenser 10, with the cartridge 1 held by the handle 7 such that its spout 4 faces downward, the cartridge 1 is lowered with its side wall 3 slid along the side wall of the body of the support structure 15 until the spout 4 is received in and connected to the port 11 of the dispenser 10 and the flange 8 of the bottom wall 2 engages the top end of the support structure 15. Since the flange 8 is supported by the support structure 15, the container cartridge 1 will never be deformed even though its side wall 3 is flexible.

When the spout 4 of the container cartridge 1 is inserted into the supply port 11 of the dispenser 10, the tip of a conduit pipe 12 protruding into the supply port 11 from its bottom penetrates through the cap 6, so that the beverage in the cartridge 1 can flow into the pipe 12. The top wall 5, including the spout 4, is thick and rigid enough, however, so that when the pipe 12 penetrates through the cap 6, the spout 4 will not be pushed up by the pipe 12.

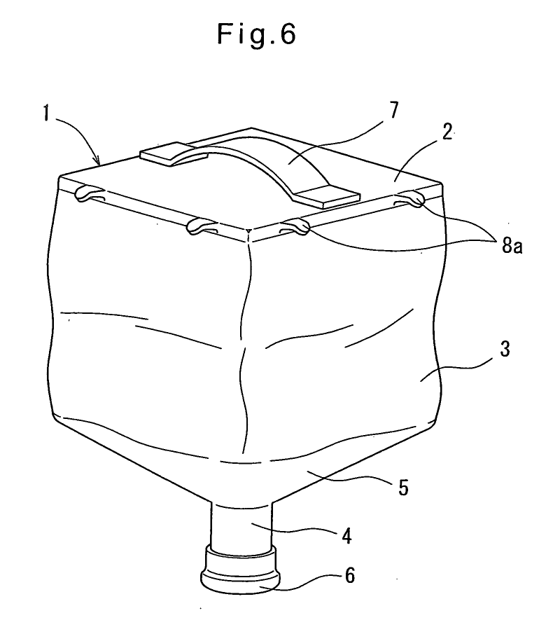

FIG. 6 shows a modification of the container cartridge 1 of the first embodiment, in which the flange 8 is replaced with a plurality of claws 8a protruding outwardly from the edge of the bottom wall 2. Like the flange 8, the claws 8a are adapted to engage the top end of the support structure 15.

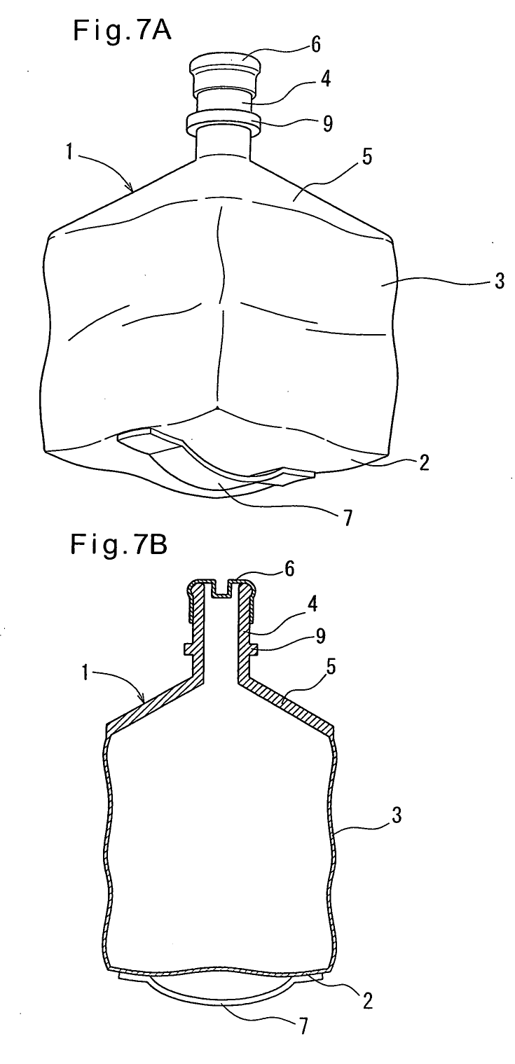

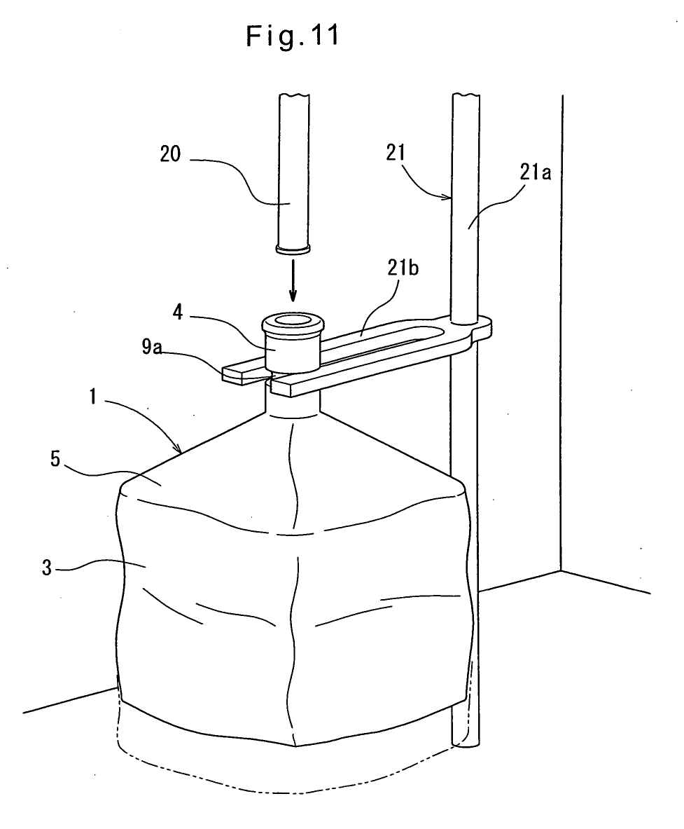

FIGS. 7 to 11 show the second embodiment. As shown in FIGS. 7A and 7B, the container cartridge 1 of the second embodiment is basically of the same structure as the container cartridge 1 of the first embodiment, and differs therefrom only in that the bottom wall 2 is thin, and in that a flange 9 is provided around the spout 4.

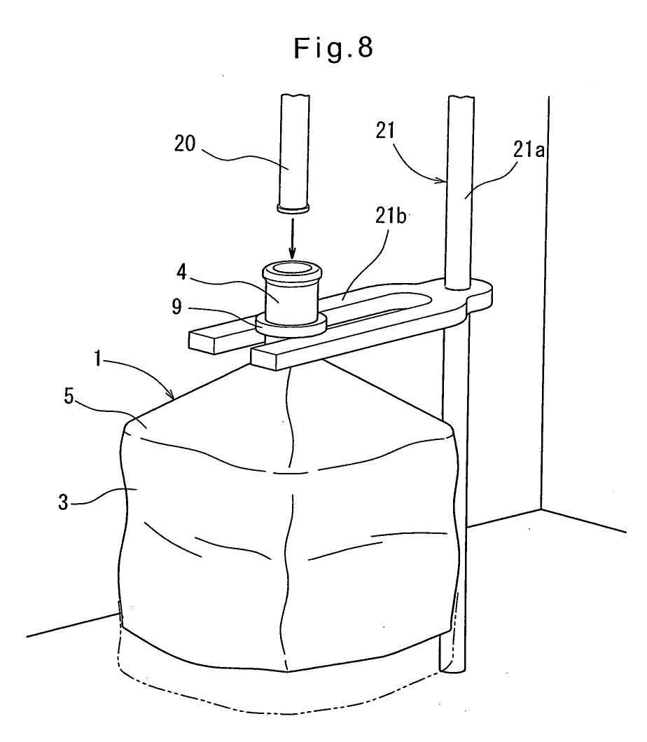

As shown in FIG. 8, beverage is poured into the container cartridge 1 through a hose 20 with the flange 9 supported on a bifurcated engaging member 21b secured to a rod 21a of a support 21 such that the container cartridge 1 is hung from the bifurcated member 21b. With this arrangement, the spout 4 is stably fixed in position so as to be always located right under the outlet port of the hose 20. As the amount of beverage in the cartridge 1 increases, the side wall 3 will expand as shown by two-dot chain line under the weight of the beverage in the cartridge. Thus, beverage can be easily poured into the cartridge 1.

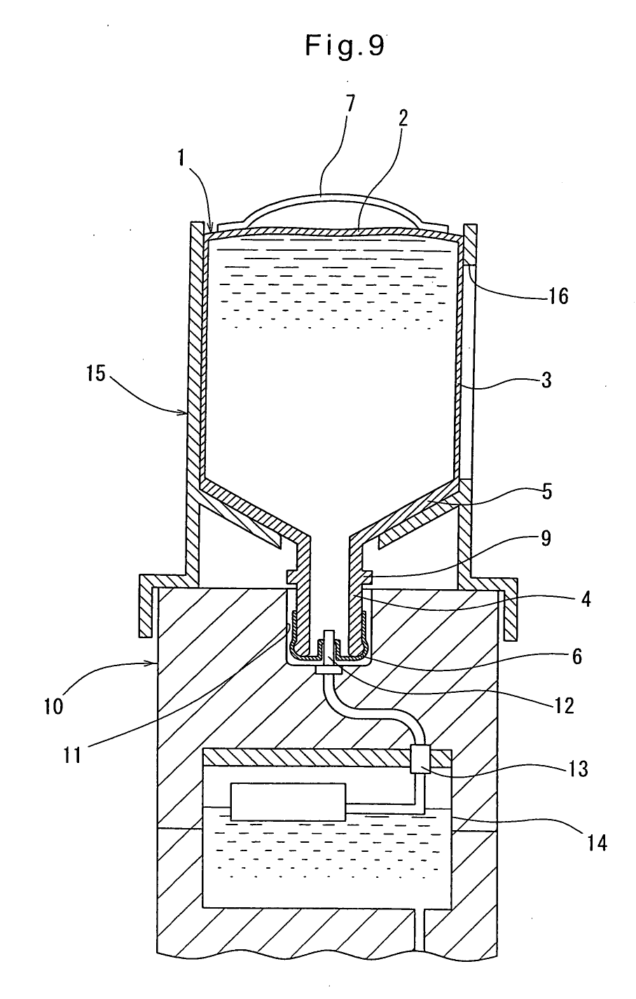

FIG. 9 shows how the container cartridge 1 is set in a dispenser 10. As shown, the container cartridge 1 is set with its spout 4 facing downward so as to be connected to a supply port 11 formed in the top surface of the dispenser 10. When the spout 4 is inserted into the supply port 11, the tip of a conduit pipe 12 will penetrate through the cap 6. The support structure 15 supports the top wall 5 of the cartridge 1 around the spout 4, and surrounds its flexible side wall 3 to keep the side wall 3 from collapsing downward.

The conduit pipe 12 of the dispenser 10 is connected to a tank through a float valve 13 to keep the amount of beverage in the tank 14 to a predetermined level even though the flexible cartridge 1 is compressed under the atmospheric pressure. A vertical slit 16 is formed in one side of the body of the support structure 15 so that the level of the beverage in the container cartridge 1 set in the support structure 15 can be checked therethrough.

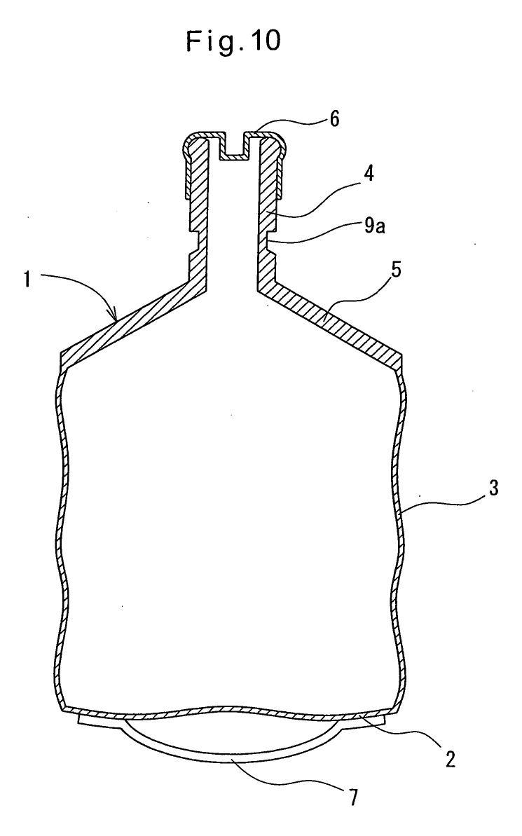

FIG. 10 shows a modification of the second embodiment, in which instead of the flange 9, a groove 9a is formed around the spout 4. The groove 9a is defined by an upper wall perpendicular to the spout 4 and a radially outwardly inclined lower wall. In this arrangement, beverage is poured into the container cartridge 1 through a hose 20 with the bifurcated engaging member 21b of the support 21 inserted in the groove 9a from both sides of the spout 5 such that the container cartridge 1 is hung from the bifurcated member 21b. With this arrangement, too, the spout 4 is stably fixed in position so as to be always located right under the outlet port of the hose 20.

The container cartridge of either embodiment is a bottle having a square cross-section, and made of a polyethylene. But the cartridge according to the present invention is not limited to such a shape. For example, it may be a bottle having a round cross-section. Also, it may be made of a material other than a polyethylene.

What is claimed is:

1. A container cartridge for use with a beverage dispenser, comprising a bottom wall, a side wall and a top wall formed with a spout through which beverage is adapted to be introduced into and discharged from the container cartridge, said container cartridge being adapted to be set in the dispenser with said spout facing downward so that said spout is connected to an upwardly facing supply port of the dispenser, whereby beverage in said container cartridge is supplied into the dispenser, at least said side wall being sufficiently flexible so as to be collapsible.

2. The container cartridge of claim 1 wherein said bottom wall, said side wall and said top wall, including said spout, are integrally formed of a common thermoplastic synthetic resin, said side wall being sufficiently thin so as to have flexibility.

3. The container cartridge of claim 1 further comprising a carrying handle mounted to said bottom wall.

4. The container cartridge of claim 1 wherein said bottom wall, including said spout, has rigidity.

5. The container cartridge of claim 1 wherein said spout is provided with an engaging portion for engaging a support member such that said container cartridge is hung from the support member with said spout facing upward.

6. The container cartridge of claim 5 wherein said engaging portion is a flange or a groove formed around said spout.

7. The container cartridge of claim 1 wherein said bottom wall has rigidity, and is provided with a flange or a plurality of claws protruding outwardly of said side wall.

8. A support structure for supporting the container cartridge of claim 7 for use with a beverage dispenser, wherein said support structure comprises a frame member supported on the beverage dispenser and surrounding the container cartridge such that the flange or the plurality of claws protruding from the edge of the bottom wall of the container cartridge are adapted to engage the top end of said support structure when the container cartridge is set in the dispenser.
